(19) United States
(12) Patent Application Publication
(10) Pub. No.: US 2019/0080272 A1
(43) Pub. Date: Mar. 14, 2019

(54) LOGISTICS WORK HISTORY INFORMATION MANAGEMENT UTILIZATION SYSTEM

(71) Applicant: Nittsu Research Institute and Consulting, Inc., Tokyo (JP)

(72) Inventors: Hiroshi INOUE, Tokyo (JP); Kisho IIZUKA, Tokyo (JP)

(73) Assignee: Nittsu Research Institute and Consulting, Inc., Tokyo (JP)

(21) Appl. No.: 15/702,382

(22) Filed: Sep. 12, 2017

(51) Int. Cl. G06Q 10/06; G06Q 10/08

(52) U.S. Cl. CPC G06Q 10/06393; G06Q 10/08

(57) ABSTRACT

Information is appropriately managed for a logistics work. A compact terminal includes a work time measurement unit that measures, at a set measurement time, a time spent by a site worker to perform a work corresponding to a set work item, and transmits a measurement result to a management server. The management server includes an operation environment master that stores an operation status of a logistics facility for each customer as a comparison target extraction condition of the logistics facility, and a bench marking unit, in the case where there is a comparison request with a logistics facility of another customer from a customer terminal of a customer, that reads out a comparison target extraction condition similar to a comparison target extraction condition of the customer of a request origin of the comparison request from the operation environment master, and compares a measurement result in the logistics facility of the another customer corresponding to the read-out comparison target extraction condition, and a measurement result in the logistics facility of the customer of a request origin of the comparison request.

### BACKGROUND OF THE INVENTION

### Field of the Invention

The present invention relates to a logistics work history information management utilization system that attempts a rationalization of a logistics work, by generating work history information by measuring and calculating a time, cost or the like required for a work, for each work performed by a site worker at a logistics site, and managing and utilizing this work history information.

### Related Art

Conventionally, in order to attempt a rationalization of a logistics work, measuring a work time required for each logistics work (for example, various types of warehousing, inspection, picking, delivery or the like) performed by a site worker is performed in a logistics facility (for example, various types of warehouses, factories, distribution centers, port freight facilities or the like) used by a warehouse operation company, shipping enterprise or the like.

Measurement of a work time required for this logistics work is performed, for example, by the following first method, second method, and third method. First, in the first method, a site worker fills out a work time in a mark sheet at fixed time intervals (for example, 15 minute intervals or the like). Then, measurement of the work time is performed, by converting the mark sheet that an office worker has finally filled out for one day by Optical Character Recognition (OCR), and turning this converted mark sheet into data. Moreover, in the second method, a site worker fills out a designated paper at fixed time intervals. Then, measurement of the work time is performed, by having the office worker collect the final designated paper for one day, and turn the filled-out content of the designated paper into data by manual input. In addition, in the third method, a manager interviews a site worker about a work engagement ratio of one day. Then, measurement of the work time is performed, by having the manager proportionally divide the working hours into times for each work, by assuming that the site worker always performs work with this ratio, and turn the divided working hours into data. Alternatively, technology for measuring a business time for each of a plurality of business items to be performed by a worker is disclosed in Patent Document 1.

### PATENT DOCUMENT 1

Japanese Unexamined Patent Application, Publication No. 2002-107473

### SUMMARY OF THE INVENTION

However, in general measurement methods of a work time such as the above described first method to third method, there will be cases where various problems will occur. For example, in the case where using the above described first method or second method, there will be the problem of forgetting to fill out the mark sheet or designated paper, and an input mistake occurring. Moreover, in the case where using the third method, there will be the problem of a fluctuation in accuracy or the like occurring due to an interview. Moreover, the technology disclosed in Patent Document 1 is technology for measuring, for example, a work time of a business work such as a telephone service or a filing service, and is not appropriate for measurement of a logistics work.

To begin with, unlike a line production or the like of a factory where a same work is repeated, at a logistics site, site workers perform a plurality of different works, such as unloading, warehousing, picking, loading, and distribution processing such as repacking, labeling, kitting, reworking, or the like, in each time band. Accordingly, it will be difficult for a manager to observe the extent of time required for a work by a site worker, and measurement of work productivity or the like will be difficult.

Accordingly, the present invention provides a logistics work history information management utilization system for appropriately managing information for a logistics work.

According to the present invention, a logistics work history information management utilization system is provided that includes a compact terminal held by a site worker of a logistics facility, and a management server connected to the compact terminal via a network, wherein the compact terminal includes a work time measurement unit that measures, at a set measurement time, a time spent by the site worker to perform a work corresponding to a set work item, and transmits a measurement result to the management server, and wherein the management server includes an operation environment master that stores an operation status of a logistics facility for each customer as a comparison target extraction condition of the logistics facility, and a bench marking unit, in the case where there is a comparison request with a logistics facility of another customer from a customer terminal of a customer, that reads out a comparison target extraction condition similar to a comparison target extraction condition of the customer of a request origin of the comparison request from the operation environment master, and compares a measurement result in the logistics facility of the another customer corresponding to the read-out comparison target extraction condition, and a measurement result in the logistics facility of the customer of a request origin of the comparison request.

It becomes possible to appropriately manage information for a logistics work.

### BRIEF DESCRIPTION OF THE DRAWINGS

FIG. 1 is a block diagram of a network configuration that includes a configuration of a logistics work history information management utilization system of an example of the present invention;

FIG. 2 is a figure of a compact terminal application menu screen;

FIG. 3 is a figure of a compact terminal application work item screen;

FIG. 4 is a figure of work item data;

FIG. 5 is a figure of work item data;

FIG. 6 is a figure of work unit-price report data;

FIG. 7 is a figure of a cost registration screen;

FIG. 8 is a figure of bench marking item data;

FIG. 9 is a flow chart for explaining a bench mark of a work time;

FIG. 10 is a flow chart for explaining a bench mark of a work unit-price; and

FIG. 11 is a flow chart for explaining a bench mark of work productivity.

### DETAILED DESCRIPTION OF THE INVENTION

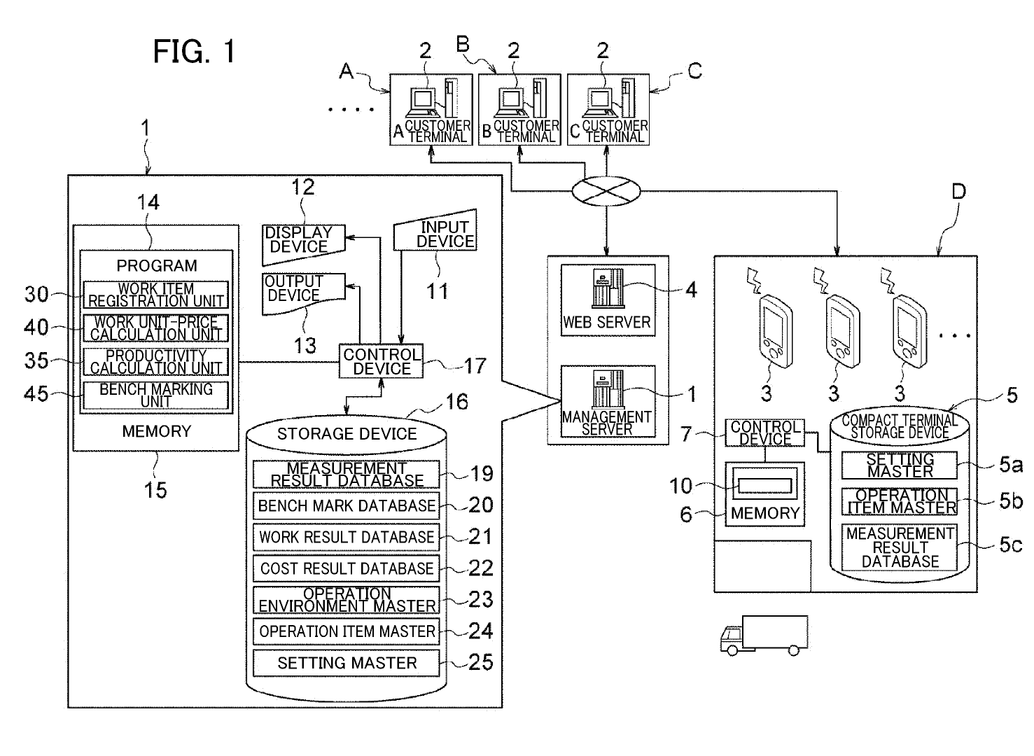

Hereinafter, embodiments of the present invention will be described in detail, by referring to the figures. FIG. 1 is a block diagram of a network configuration that includes a logistics work history information management utilization system of an embodiment of the present invention. The present embodiment includes a management server 1, a plurality of customer terminals 2, a plurality of compact terminals 3, and a WEB server 4.

The management server 1 is a device that manages measurement results of a work time in a logistics work, and work history information generated based on the measurement results. The management server 1 is constituted to be capable of transmitting and receiving data between the respective plurality of customer terminals 2 and plurality of compact terminals 3, via the WEB server 4 and a network. The management server 1 collects measurement results of a work time from the plurality of compact terminals 3. Also, the management server 1 generates work history information based on the collected measurement results of a work time, and manages this work history information. Moreover, the management server 1 provides the work history information to the plurality of customer terminals 2. As a result, in the present embodiment, it becomes possible for a customer to utilize work history information. The management server 1 is set in a system operation company that performs a service to provide such work history information.

The plurality of customer terminals 2 are terminals that are used by customers of the system operation company to refer to work history. The plurality of customer terminals 2 are respectively set in a customer base A, a customer base B, and a customer base C, which are bases of customers. A customer is, for example, a warehouse operation company or a shipping enterprise.

The plurality of compact terminals 3 are compact terminals held by site workers, in a logistics facility D, which is a facility that performs logistics work. Here, the logistics facility D is a facility where various types of logistics work are performed, such as a warehouse, factory, distribution center, port/railway/air freight facility, base, or shop. In the present embodiment, a description will be made by assuming the case where the logistics facility D is a warehouse.

The management server 1 and the WEB server 4 can be implemented, for example, by a server device. Moreover, each of the plurality of customer terminals 2 can be implemented, for example, by a personal computer. In addition, each of the plurality of compact terminals 3 can be implemented by a smartphone, a handheld terminal, or a portable terminal.

The compact terminal 3 includes a storage device 5 for storing various types of databases, various types of masters, and various types of files, a memory 6 for storing a program to cause prescribed functions to be implemented, and a control device 7 for controlling the respective operations of the storage device 5 and the memory 6. Moreover, the storage device 5 includes a setting master 5a, a work item master 5b, and a measurement result database 5c. The setting master 5a registers, as a master, setting items related to a work time measurement, such as an estimated time to start a work, and a measurement interval of a work time. The work item master 5b registers, as a master, warehouse work such as unloading, warehousing, inspection, picking, loading, and distribution processing of a work item 3a. The measurement result database 5c stores, as measurement result data for each worker, what logistics work has been performed at the logistics facility D, on what day-month-year.

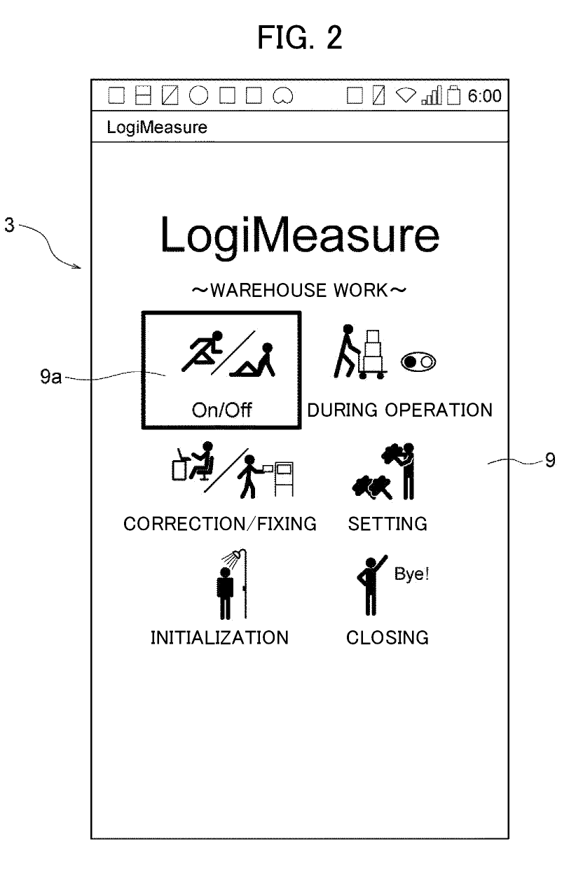

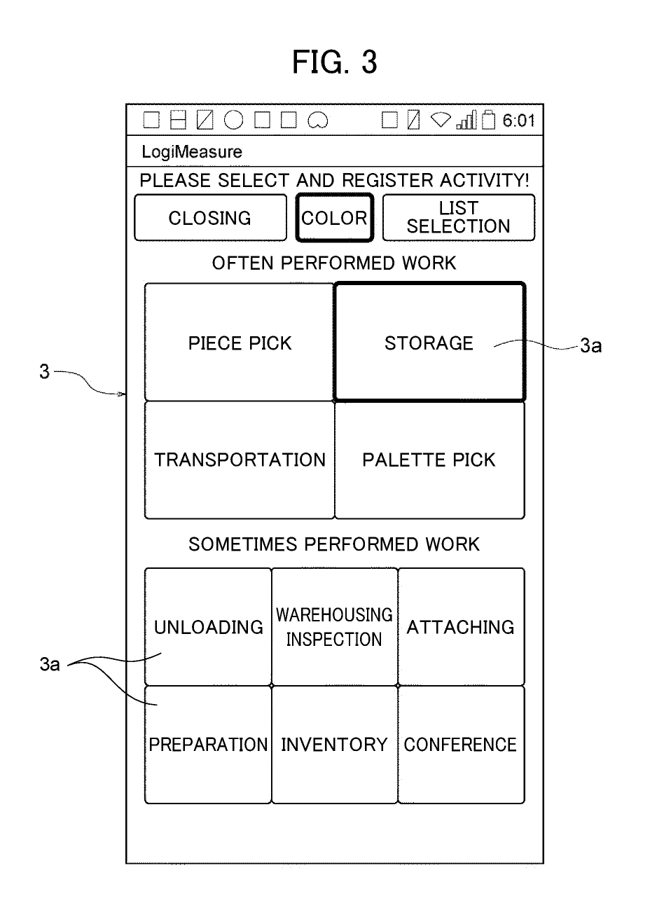

Moreover, a work time measurement unit 10 is implemented, by a program stored in the memory 6. The work time measurement unit 10 measures the time that a site worker spends on a work for each work item, at fixed time intervals (for example, 10 minute intervals), and stores this measurement result data in the measurement result database 5c of the storage device 5. Moreover, the work time measurement unit 10 automatically uploads this measurement result data in one batch to the management server 1. The work time measurement unit 10 performs a notification to prompt a measurement execution of a work time to the site worker, at prescribed time intervals, so that a work time is measured at fixed time intervals (for example, 10 minute intervals). For example, in order to perform a notification, an alarm sound is automatically emitted when a fixed time arrives. Note that, the notification is not limited to a sound, and may be performed by vibration, lights or the like. Moreover, the compact terminal 3 displays a menu 9, such as shown in FIG. 2, on a touch panel provided on an operation front side. Also, the compact terminal 3 receives a selection of “measurement execution” 9a of a work, for example, from within the menu 9, from the site worker responding to an alarm sound. Then, as shown in FIG. 3, the compact terminal 3 displays a screen for the site worker to select a work item. The site worker selects a work presently performed from the plurality of displayed work items 3a. Measurement of a work time is implemented by such a process.

The management server 1 includes an input device 11, a display device 12, an output device 13, a program 14, a memory 15, a storage device 16, and a control device 17. The input device 11 is a device for a user of a system operation company to perform an operation to the management server 1. The input device 11 is implemented by a keyboard, mouse or the like. The display device 12 is used for a user to monitor input data. The output device 13 outputs various types of data. The memory 15 stores the program 14 for causing functions of the management server 1 to be implemented. The storage device 16 stores various types of databases and master files. The control device 17 integrally controls and processes the entire system.

The storage device 16 includes databases such as a measurement result database 19, a bench mark database 20, a work result database 21, and a cost result database 22, and various types of masters such as an operation environment master 23, a work item master 24, and a setting master 25.

The measurement result database 19 is a database that sequentially stores measurement result data of work times uploaded to the management server 1 for each worker from the compact terminals 3. The bench mark database 20 stores measurement result data totaled for each work type such as food or electronic equipment. Here, this total is performed in a prescribed cycle by a batch process. In the case where there is a comparison request from a customer afterwards, this measurement result data is used as bench marking data for comparing by drawing data corresponding to a comparison target extraction condition. Accordingly, in the bench mark database 20, the measurement result data and comparison target extraction condition are stored in association with each other. The work result database 21 is a database that stores a process result number of a work. The cost result database 22 is a database that stores a work unit-price for calculating what cost is required for each work.

The operation environment master 23 stores an operation status (for example, work type, packing style, package size, floor space or the like) of a logistics facility for each customer. In the case where there is a comparison request from a customer afterwards, this operation status is used as a comparison target extraction condition. The work item master 24 stores work items performed by site workers at a logistics facility. Information stored in the work item master 24 is used, for example, by a work item registration unit 30 or the like, which will be described afterwards. The setting master 25 has various types of settings stored in the management server 1. For example, in the case where there is a comparison request from a customer afterwards, it may be required to perform a similarity judgment of comparison target extraction conditions, and a standard or the like for judging to be similar is stored in this case.

Moreover, the management server 1 includes a work item registration unit 30, a work productivity calculation unit 35, a work unit-price calculation unit 40, and a bench marking unit 45.

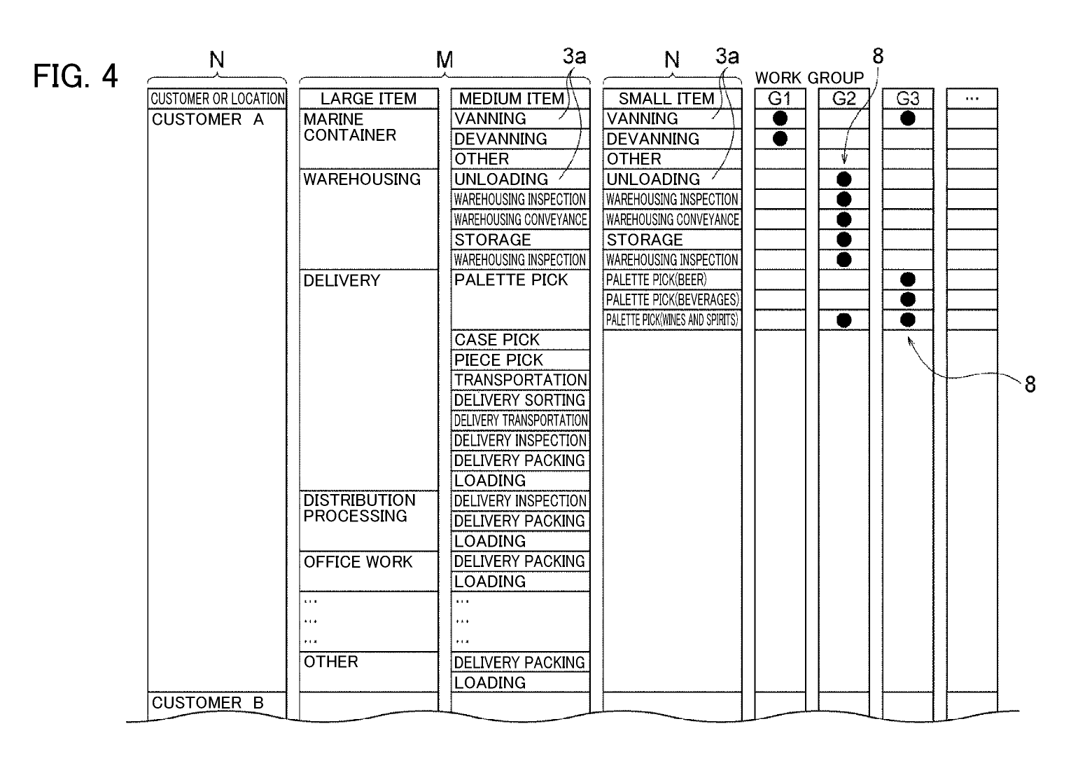

The work item registration unit 30 sets common setting items (prescribed form) M that cannot be changed at a user side, and free setting items N that can be freely set at a user side on a lower level of this, as work item settings of the compact terminal 3 held by a worker, such as shown in the work item registration screen of FIG. 4. Also, when there is a setting request of work item data 8 from the compact terminal 3, the work item registration unit 30 automatically downloads work item settings in one batch to the compact terminal 3.

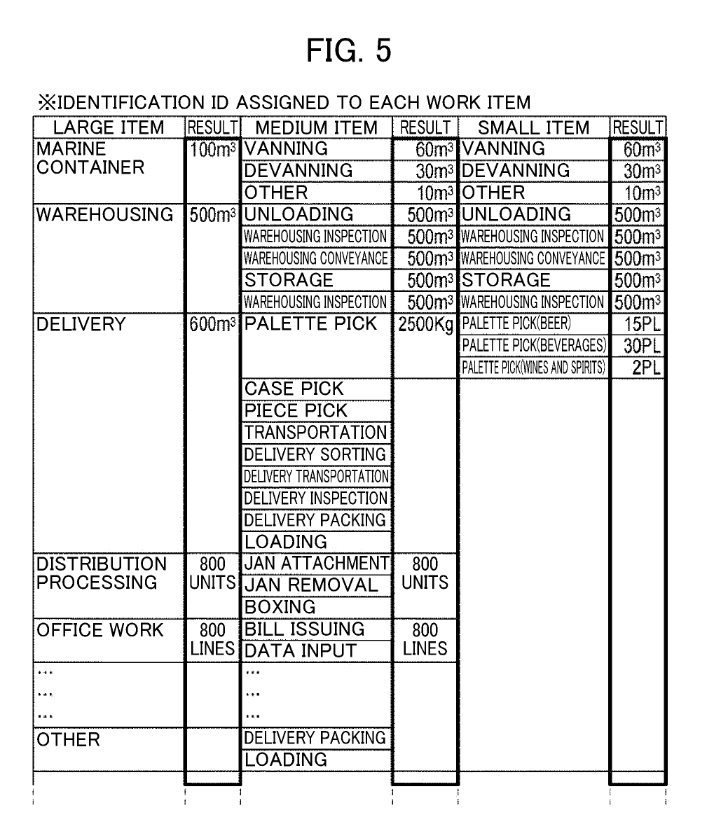

The work productivity calculation unit 35 totals measurement times for each work item, such as shown in the work item registration screen of FIG. 5, calculates a work result for each person by linking to an ID of a work item, and registers work results in the work result database 21 by calculating individual work productivities.

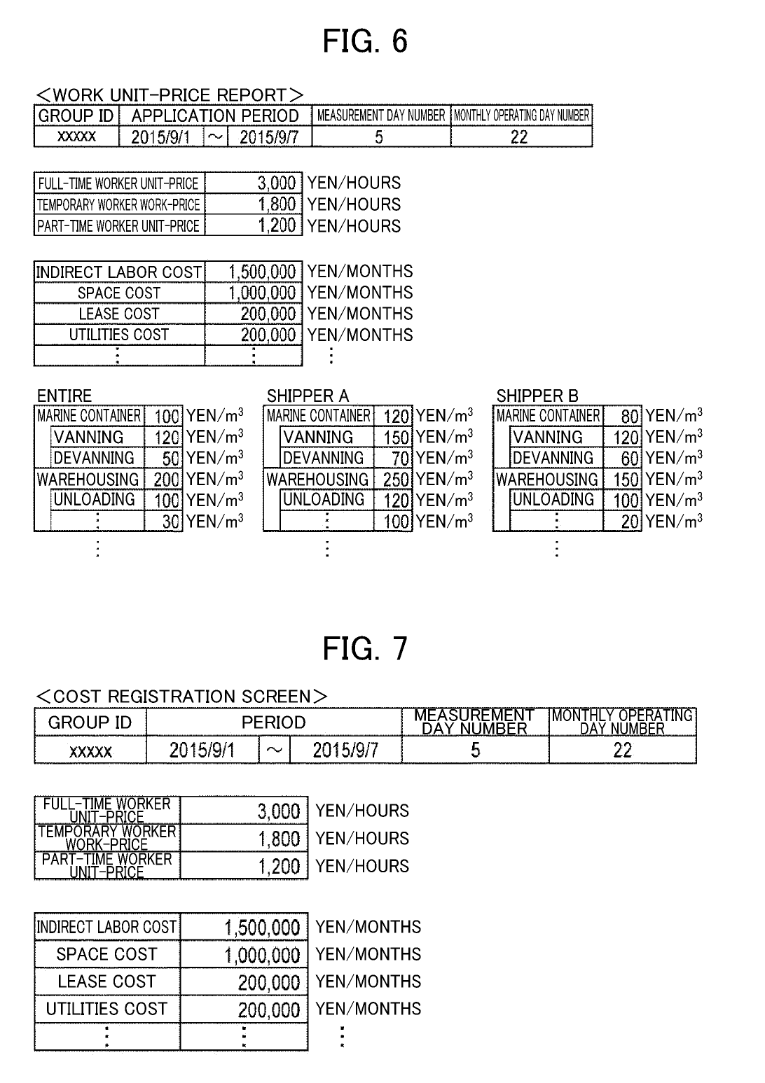

As shown in FIG. 6 and FIG. 7, the work unit-price calculation unit 40 calculates a direct labor cost for each work by a measured work time and unit-price, calculates a cost (work unit-price) for each work result (m³/kg/line/case/item or the like), and registers a work registration, which applies an amount of money obtained by proportionally dividing monthly costs in a ratio of measurement day number/monthly operating day number, in the cost result database 22.

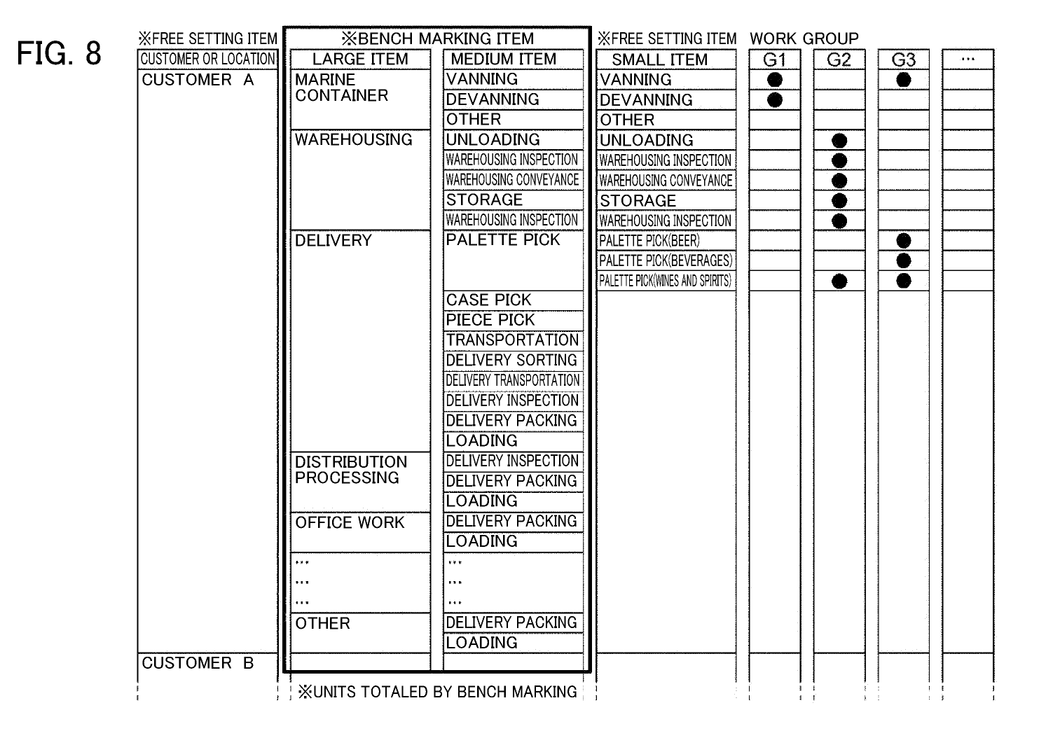

As shown in FIG. 8, the bench marking unit 45 registers, for example, information such as the following 1. to 4. in the operation environment master 23, as information that shows an operation status of a logistics facility for each customer. In the case where there is a comparison request afterwards, such as described above, the information is used as a comparison target extraction condition.

1. Customer attributes . . . work type, packing style (palette, box, bare), main product size, warehouse floor space, picking method, worker number

2. Measurement data . . . work time ratio, employee division (part-time worker, contract worker, full-time worker)

3. Productivity

4. Work unit-price ratio

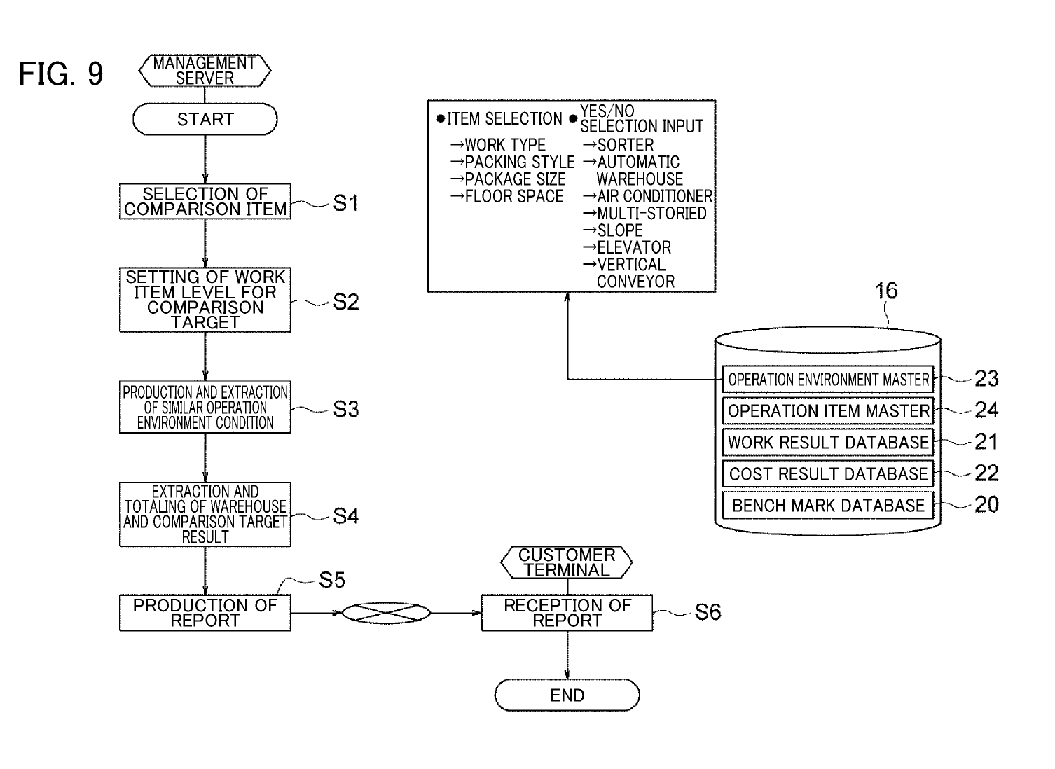

Moreover, information for equipment of a logistics facility such as described in FIGS. 9, 10, and 11 may be additionally included as a comparison target extraction condition. Specifically, information may be included, such as the presence or absence of a sorter, whether or not it is an automatic warehouse, whether or not an air conditioner is installed, whether or not it is multi-storied (multiple floors), whether or not a slope is present, whether or not an elevator is present, and whether or not a vertical conveyor is present.

Heretofore, the configuration of the present embodiment has been described. In the present embodiment with such a configuration, in the case where there is a comparison request for comparing a rationality of work of another warehouse, in which an operation status is similar to that of a warehouse of a customer's own logistics facility D, by the customer terminal 2 of the customer, the management server 1 and the customer terminal 2 perform a bench mark process in accordance with this request.

First, a bench mark process based on a “work time” will be described by referring to the flow chart of FIG. 9. The bench marking unit 45 selects a work item to be a target of comparison, based on a comparison request received from the customer terminal 2 (step S1). Next, the bench marking unit 45 sets a free setting item N of a Level that can be freely set at a user side, based on the comparison request received from the customer terminal 2 (step S2). Afterwards, the bench marking unit 45 refers to the operation environment master 23, and extracts a comparison target condition to become a similar operation environment (step S3). Then, the bench marking unit 45 extracts comparison target data, which agrees with the comparison target condition to become a similar operation environment, from the bench mark database 20, and totals the data (step S4). Then, the bench marking unit 45 outputs a totaled result as a prescribed format (for example, an EXCEL (registered trademark) report) (step S5). On the other hand, the customer terminal 2 receives a report (step S6), and receives a comparison report of a work time of the other warehouse.

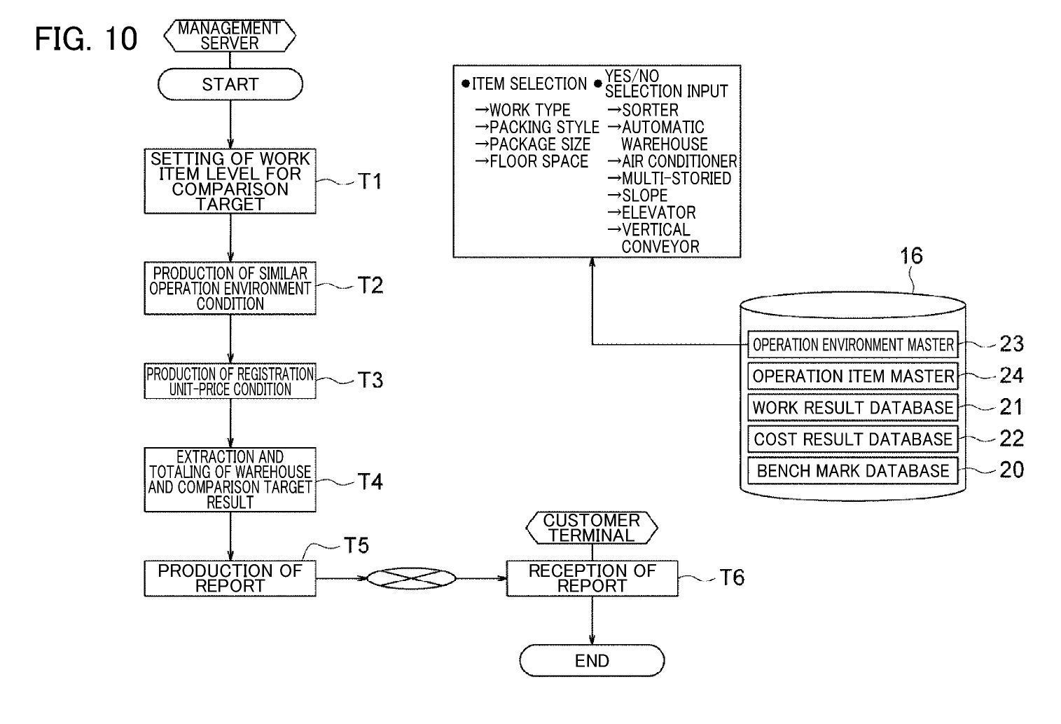

Next, a bench mark based on a “work unit-price” will be described by referring to the flow chart of FIG. 10. First, the bench marking unit 45 sets a free setting item N of a Level that can be freely set at a user side, based on a comparison request received from the customer terminal 2 (step T1). Afterwards, the bench marking unit 45 refers to the operation environment master 23, and generates a comparison target condition to become a similar operation environment (step T2). Afterwards, the bench marking unit 45 confirms a registration unit (Kg/m³/case/item) of a work unit-price of the bench mark database 20, and generates a registration unit condition (step T3). Then, the bench marking unit 45 extracts comparison target data, which agrees with the comparison target condition to become a similar operation environment and the registration unit condition, from the bench mark database 20 (step T4). Moreover, the bench marking unit 45 outputs a totaled result as a prescribed format (for example, an EXCEL report) (step T5). On the other hand, the customer terminal 2 receives a report (step T6), and receives a comparison report of a work unit-price of the other warehouse.

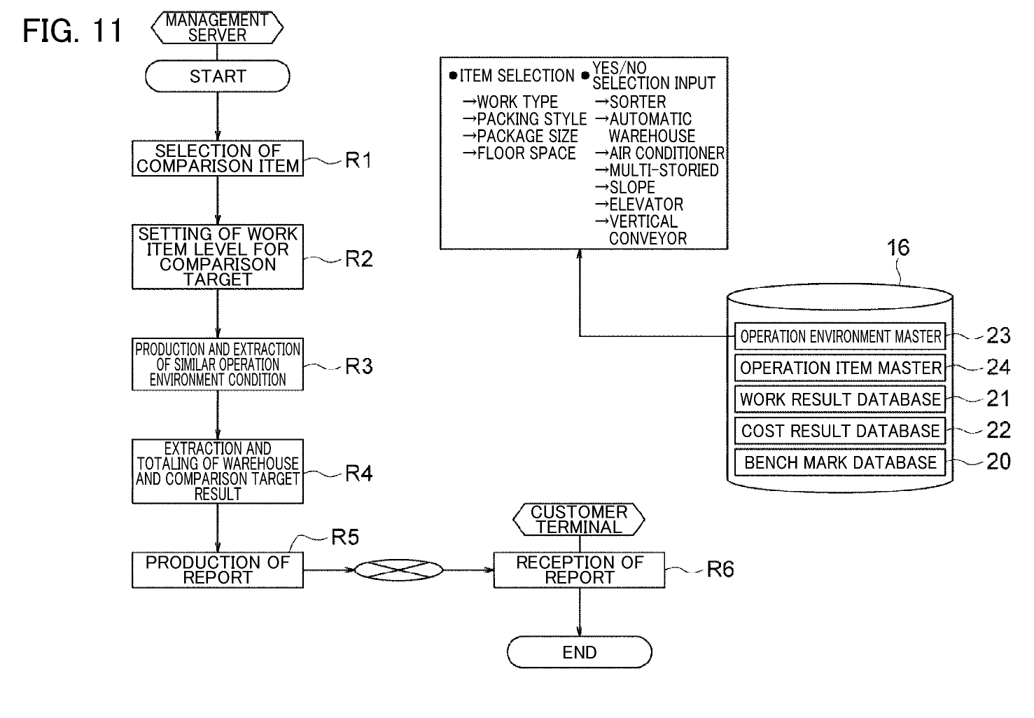

Next, a bench mark based on “work productivity” will be described by referring to the following flow chart of FIG. 11. First, the bench marking unit 45 sets a free setting item N of a Level that can be freely set at a user side, based on a comparison request received from the customer terminal 2 (step R1). Afterwards, the bench marking unit 45 refers to the operation environment master 23, and generates a comparison target condition to become a similar operation environment (step R2). Afterwards, the bench marking unit 45 confirms a registration unit (kg/m³/case/item) of work productivity of the bench mark database 20, and generates a registration unit condition (step R3). Then, the bench marking unit 45 extracts comparison target data, which agrees with the comparison target to become a similar operation environment and the registration unit condition, from the bench mark database 20 (step R4). Moreover, the bench marking unit 45 outputs a totaled result as a prescribed format (for example, an EXCEL report) (step R5). On the other hand, the customer terminal 2 receives a report (step R6), receives a comparison report of work productivity of the other warehouse, and as a result, an information processing service is provided that compares the work time, work unit-price, and work productivity.

The present embodiment described above accomplishes various effects. The problem of the prior art will be described as a premise for the description of this effect. As a premise, work handled across various fields such as warehousing, inspection, picking, delivery, and distribution processing, a plurality of packing styles, and shipment articles are handled at a work site of a logistics facility, for each time band of each worker, and therefore it will be a difficult situation to understand how much time and cost is spent for a work, or how much productivity or cost is taken for a work.

Accordingly, in the prior art, in order to understand a work situation by measuring a time of a work, it will be necessary to adjust work items of various types of logistics works, such as unloading, warehousing, inspection, picking, loading, or distribution processing, and perform data input for work sampling and additionally a measurement result by the description of a mark sheet by a worker, or by a measurer, and there will be the problem of it becoming very complex work.

Moreover, since there are various ways of performing time measurement in each logistics facility, and the acquisition conditions of data are different, there will be the problem of it being difficult to perform a comparison with another logistics facility.

On the other hand, according to the present embodiment, by providing a compact terminal for measurement by a company that provides a measurement service, and an information system of the WEB, special skills will be unnecessary, and measurement of a work time can be easily performed. Moreover, by setting work item settings of a compact terminal for measurement in one batch at a WEB side, the compact terminal side can be automatically set as it is, and as a result, various types of work can be performed, such as goods reception, warehousing inspection, indoor carriage for warehousing, storage, distribution processing, inventory, picking, inspection, packing, sorting, indoor carriage for shipping, and loading, by one worker, a plurality of works can be performed for a similar location or a similar work target package, and a work time can be easy measured without taking time, and the convenience can be raised further, even with a logistics work for which it is difficult to understand, for example, the extent of time spent for this work, or the work situation by measuring a work time.

Moreover, according to the present embodiment, at the time when set in one batch at a WEB side, a comparison can be implemented with another logistics facility by a common axis by providing a common work item that cannot be changed at a user side and a work item that can be freely set at a user side on a lower level of this, and a customer's own warehouse comparison can be implemented with a high degree of freedom by a different axis.

In addition, according to the present embodiment, calculation of work productivity and a work unit-price can be performed by registering a work result or work cost, in the measured time. Moreover, the work time, productivity, work unit-price or the like can be compared and verified with another base, by performing a linking process with a calculation of a work result, work cost, or the like that considers the above described common axis.

Note that, each of the devices included in the above described logistics work history information management utilization system can be implemented by hardware, software, or a combination of these. Moreover, a logistics work history information management utilization method performed by each of the devices included in the above described logistics work history information management utilization system can be implemented by hardware, software, or a combination of these. Here, implemented by software has the meaning of being implemented by a computer reading and executing a program. The program is stored by using various types of non-transitory computer readable mediums, and can be supplied to the computer. A non-transitory computer readable medium includes a tangible storage medium, for which there are various types of entities. Examples of non-transitory computer readable mediums include a magnetic recording medium (for example, a flexible disk, magnetic tape, and hard disk drive), a magneto-optical medium (for example, a magneto-optical disk), a CD-ROM (Read Only Memory), a CD-R, a CD-R/W, and a semiconductor memory (for example, a mask ROM, a Programmable ROM (PROM), an Erasable PROM (EPROM), a flash ROM, and a random access memory (RAM)).

Moreover, while the above described embodiment is a preferred embodiment of the present invention, the range of the present invention is not limited to this embodiment, and is capable of being executed in a form that performs various changes in a range that does not deviate from the present invention.

### FIRST MODIFIED EXAMPLE

A swipe operation may be accepted in the user interface displayed on a touch panel of the compact terminal 3, described above by referring to FIG. 3. Also, the content of the selection buttons of work items may be switched in accordance with the swipe operation. As a result, by pressing a button of a list selection once, there will be no time taken to switch the selection buttons of work items from this list, and the usability for a site worker will improve.

### SECOND MODIFIED EXAMPLE

In the above described embodiment, the management server 1 constructs each database by using measurement result data collected from the compact terminal 3. In addition to this configuration, since the management server 1 constructs each database, measurement results measured by the first method, second method, and third method such as described in the Related Art may be additionally used. As a result, a logistics facility not using the compact terminal 3, for example, can be set to a comparison target.

### THIRD MODIFIED EXAMPLE

A Warehouse Management System (WMS), which is a warehouse management system, may be combined with the above described embodiment. For example, by having work result data obtained from the WMS coordinate with information stored in each database of the management server 1, information for a logistics Key Performance Indicator (KPI), such as shipping productivity or picking productivity, can also be set to a comparison target. Also, a comparison result can be totaled and output in a prescribed format (for example, an EXCEL report). Moreover, tables and graphs or the like may be generated based on the totaled information, and these generated tables and graphs may be output. For example, a table of information for productivity may be output, a scatter chart of information of productivity and logistics may be output, or a transition graph of information of productivity or logistics may be output. Moreover, these tables and graphs may coordinate with each other. For example, when a customer referring to a graph designates a concerned day of productivity, a graph that shows the transition of one day on this designated day may be output.

### FOURTH MODIFIED EXAMPLE

A position measurement function may be added to the compact terminal 3, and position information of the compact terminal 3 (namely, position information of a site worker holding the compact terminal 3) measured by this position measurement function may be additionally output. For this point, if the logistics facility is indoors, a position measurement may be performed, for example, by the Global Positioning System (GPS). On the other hand, in the case where the logistics facility is in a room and measurement by GPS is difficult, a measurement may be performed, for example, by communication complying with a standard such as Bluetooth Low Energy (BLE), Wi-Fi, or Ultra Wide Band (UWB). For example, a plurality of communication devices complying with BLE are distributed and arranged within the logistics facility. Also, a measurement can be performed, by having the compact terminal 3 receive a beacon transmitted by this communication device. An output of the position information may be displayed, for example, overlapping the position at which a site worker performs a work on a map of the logistics facility. As a result, it is possible to visually refer to a site worker performing what work at what time and at what position. Moreover, in this case, conditions for each date, logistics facility, and work may be combined, and information can be displayed along these combined conditions. As a result, analysis can be performed by various viewpoints. In addition, for example, a comparison of before and after changing a layout of a logistics facility or the like can also be performed.

### EXPLANATION OF REFERENCE NUMERALS

A, B, C customer base
D logistics facility
1 management server
2 customer terminal
3 compact terminal
20 bench mark database
23 operation environment master
30 work item registration unit
35 productivity calculation unit
40 work unit-price calculation unit
45 bench marking unit

What is claimed is:

1. A logistics work history information management utilization system comprising a compact terminal held by a site worker of a logistics facility, and a management server connected to the compact terminal via a network,
wherein the compact terminal includes a work time measurement unit that measures, at a set measurement time, a time spent by the site worker to perform a work corresponding to a set work item, and transmits a measurement result to the management server, and
wherein the management server includes an operation environment master that stores an operation status of a logistics facility for each customer as a comparison target extraction condition of the logistics facility, and
a bench marking unit, in the case where there is a comparison request with a logistics facility of another customer from a customer terminal of a customer, that reads out a comparison target extraction condition similar to a comparison target extraction condition of the customer of a request origin of the comparison request from the operation environment master, and compares a measurement result in the logistics facility of the another customer corresponding to the read-out comparison target extraction condition, and a measurement result in the logistics facility of the customer of a request origin of the comparison request.
